(19) United States
(12) Patent Application Publication
(10) Pub. No.: US 2026/0315297 A1
(43) Pub. Date: Oct. 15, 2026

(54) PATIENT LIFTING DEVICE

(71) Applicants: Daniel Gabbay, Arlington, VA (US); Jens Schroeder Kemp, Tampa, FL (US)

(72) Inventors: Daniel Gabbay, Arlington, VA (US); Jens Schroeder Kemp, Tampa, FL (US)

(73) Assignee: Patient Positioning Systems, LLC, Annapolis, MD (US)

(21) Appl. No.: 19/174,889

(22) Filed: Apr. 9, 2025

(51) Int. Cl. A61G 7/10

(52) U.S. Cl. CPC A61G 7/1021; A61G 7/1011

(57) ABSTRACT

A patient lifting device for pneumatically lifting a fallen patient has a body with a top surface adapted to have a patient positioned thereon, a bottom surface adapted to contact a floor, ground, or other surface, and a pneumatic lifting system between the top surface and the bottom surface and adapted to be inflated to lift the top surface relative to the bottom surface. The pneumatic lifting system comprises a top vertical layer compartment air compartment, a bottom vertical layer air compartment, an intermediate layer vertical air compartment, and an air inlet.

An upper barrier includes an upper barrier valving system that allows air to pass from the intermediate vertical layer air compartment to the top vertical layer air compartment, and a lower barrier includes a lower barrier valving system that allows air to pass from the bottom vertical layer air compartment to the intermediate vertical layer air compartment.

### BACKGROUND

The Agency for Healthcare Research and Quality estimates that over 700,000 hospitalized patients and nearly half of the 1.6 million nursing home residents in the United States fall each year. Lifting the patient who has fallen to bed or gurney height can be an arduous task.

Without mechanical assistance, a patient who is on the floor must be manually lifted by a caregiver. This can be difficult and sometimes impossible for the caregiver and can expose even the fittest of caregivers to injury. The lifting of disabled patients is a leading cause of injury in the health-care industry, with the nursing occupation having among the highest incidence of back injury. Patient lifts, such as ceiling mounted or crane-mounted lifts where a patient is lifted by a hook, are commercially available but are rarely available in a home setting and are often under-utilized in a hospital and/or caregiving setting for various reasons. For example, these lifts often occupy too much space to be kept in proximity to a patient, are difficult to operate, are difficult to transfer a patient onto, require a large amount of time to set up and/or use, and can be humiliating for a patient.

Pneumatically inflatable lifting devices have been introduced, but existing versions have proven to be less than ideal. For example, with existing inflatable lifting devices, the amount of time and/or steps it takes to lift a patient to a sufficient height is undesirably slow and/or cumbersome. In addition, the manner in which supine patients are lifted can cause undesired elevational positioning for the patient during the lift. Also, existing devices often lack sufficient lateral stability, and a patient is at risk of falling off the side or feeling as though they might.

Therefore, there is a need for an improved patient lifting device. There is a further need for a patient lifting device that can be used to lift a patient to a desired height in a reduced amount of time and/or with a reduced number of operator steps. There is a further need for a patient lifting device with improved lifting performance in terms of relative elevational positioning and/or stability. There is a further need for a patient lifting device with increased lifting speed and improved lifting performance.

### SUMMARY

The present invention satisfies one or more of these needs. In one aspect of the invention, an improved patient lifting device is provided.

In another aspect of the invention, a compact, lightweight and easily portable patient lifting device is provided to assist caregivers in lifting prone patients from a fallen position to a relatively higher position, such as a bed, table, gurney, stretcher, vehicle, or the like, for use in the home, in institutional settings, and in the outside world.

In another aspect of the invention, a patient lifting device is provided that can be used to lift a patient to a bed or gurney height in a reduced amount of time.

In another aspect of the invention, a patient lifting device is provided that can lift a patient with one or more improved lifting performance features.

In another aspect of the invention, a patient lifting device is provided that can lift a patient with one or more improved lifting performance features, such as by maintaining a desired elevational positioning of the patient along the length of the patient lifting device.

In another aspect of the invention, a patient lifting device is provided that can lift a patient with one or more improved lifting performance features, such as by maintaining a desired elevational positioning of the patient along the length of the patient lifting device, wherein the desired elevational positioning comprises helping keep the head elevated during a lifting procedure.

In another aspect of the invention, a patient lifting device is provided that can lift a patient with one or more improved lifting performance features, such as by maintaining a desired elevational positioning of the patient along the length of the patient lifting device, wherein the desired elevational positioning comprises helping keep the feet elevated during a lifting procedure.

In another aspect of the invention, a patient lifting device is provided that can lift a patient with one or more improved lifting performance features, such as by providing improved lateral stability during a lifting operation.

In another aspect of the invention, a patient lifting device is provided that can lift a patient with one or more improved lifting performance features, such as by providing improved lateral stability during a lifting operation, wherein the improved lateral stability comprises providing a cradling effect for the patient during the lifting process.

In another aspect of the invention, a patient lifting device is provided that can lift a patient with one or more improved lifting performance features, such as by providing improved lateral stability during a lifting operation, wherein the improved lateral stability comprises providing a cradling effect for the patient during the lifting process where the cradling effect elevates a lateral side of the patient lifting device above the surface the patient is positioned on.

In another aspect of the invention, a patient lifting device is provided that can lift a patient with one or more improved lifting performance features, such as by providing improved lateral stability during a lifting operation, wherein the improved lateral stability comprises providing a cradling effect for the patient during the lifting process where the cradling effect elevates a lateral side of the patient lifting device above the surface the patient is positioned on from the time the lifting starts until the patient is fully lifted.

In another aspect of the invention, a patient lifting device is provided that can lift a patient with one or more improved lifting performance features and with increased lifting speed.

In another aspect of the invention, a method of lifting a patient comprises providing a patient lifting device as described herein and using the patient lifting device as described herein.

In another aspect of the invention, a patient lifting device for pneumatically lifting a fallen patient comprises a body extending longitudinally from a first end to a second end and transversely from a right side to a left side, the body comprising a top surface adapted to have a patient positioned thereon, a bottom surface adapted to contact a floor, ground, or other surface, and a pneumatic lifting system between the top surface and the bottom surface and adapted to be inflated to lift the top surface relative to the bottom surface, wherein the pneumatic lifting system comprises a top vertical layer having a top vertical layer air compartment, a bottom vertical layer having a bottom vertical layer air compartment, an intermediate vertical layer having an intermediate layer vertical air compartment, and an air inlet connectable to an air supply which can inflate the pneumatic lifting system, wherein an upper barrier separates the top vertical layer air compartment from the intermediate vertical layer air compartment and a lower barrier separates the bottom vertical layer air compartment from the intermediate vertical layer air compartment, wherein the upper barrier comprises an upper barrier valving system that allows air to pass from the intermediate vertical layer air compartment to the top vertical layer air compartment and the lower barrier comprises a lower barrier valving system that allows air to pass from the bottom vertical layer air compartment to the intermediate vertical layer air compartment, and wherein the pneumatic lifting system is designed so that the patient lifting system can lift a patient to a height of at least 30 inches in less than about 90 seconds.

In another aspect of the invention, a patient lifting device for pneumatically lifting a fallen patient comprises a body extending longitudinally from a first end to a second end and transversely from a right side to a left side, the body comprising a top surface adapted to have a patient positioned thereon, a bottom surface adapted to contact a floor, ground, or other surface, and a pneumatic lifting system between the top surface and the bottom surface and adapted to be inflated to lift the top surface relative to the bottom surface, wherein the pneumatic lifting system comprises a top vertical layer having a top vertical layer air compartment, a bottom vertical layer having a bottom vertical layer air compartment, an intermediate vertical layer having an intermediate layer vertical air compartment, and an air inlet connectable to an air supply which can inflate the pneumatic lifting system, wherein an upper barrier separates the top vertical layer air compartment from the intermediate vertical layer air compartment and a lower barrier separates the bottom vertical layer air compartment from the intermediate vertical layer air compartment, wherein the upper barrier comprises an upper barrier valving system that allows air to pass from the intermediate vertical layer air compartment to the top vertical layer air compartment and the lower barrier comprises a lower barrier valving system that allows air to pass from the bottom vertical layer air compartment to the intermediate vertical layer air compartment, and wherein the pneumatic lifting system is designed to provide a cradling effect during the lifting of the patient where the pneumatic lifting system causes a portion of the top surface to the right side and left side of the patient to be at a higher elevation than the elevation of the top surface that is directly under the patient.

In another aspect of the invention, a method of lifting a patient from the floor or ground comprises providing a patient lifting device comprising a body extending longitudinally from a first end to a second end and transversely from a right side to a left side, the body comprising a top surface, a bottom surface, and a pneumatic lifting system between the top surface and the bottom surface and adapted to be inflated to lift the top surface relative to the bottom surface; placing the bottom surface on the floor or ground; positioning a patient on the top surface; inflating the pneumatic lifting system to cause the top surface to move away from the bottom surface to lift the patient on the top surface; cradling the patient while being lifted with a portion of the top surface; and lifting the patient 30 inches in less than 75 seconds.

### BRIEF DESCRIPTION OF THE DRAWINGS

These features, aspects, and advantages of the present invention will become better understood with regard to the following description, appended claims, and accompanying drawings which illustrate exemplary features of the invention. However, it is to be understood that each of the features can be used in the invention in general, not merely in the context of the particular drawings, and the invention includes any combination of these features, where:

FIG. 1 is a schematic perspective view of a version of a patient lifting device of the invention;

FIG. 2 is a schematic side perspective exploded view of the patient lifting device of FIG. 1;

FIG. 3 is a schematic end perspective sectional view of the patient lifting device of FIG. 1;

FIG. 4A is a schematic sectional side view of the patient lifting device of FIG. 1 in use in a patient lifting operation;

FIG. 4B is a schematic sectional side view of the patient lifting device of FIG. 1 in use at a subsequent step in a patient lifting operation;

FIG. 5A is a schematic sectional side view of the patient lifting device of FIG. 1 in use at a subsequent step in a patient lifting operation;

FIG. 5B is a schematic sectional side view of the patient lifting device of FIG. 1 in use at a subsequent step in a patient lifting operation;

FIG. 6A is a schematic sectional side view of the patient lifting device of FIG. 1 in use at a subsequent step in a patient lifting operation;

FIG. 6B is a schematic sectional side view of the patient lifting device of FIG. 1 in use at a subsequent step in a patient lifting operation;

FIG. 7 is a schematic perspective view of another version of a patient lifting device of the invention;

FIG. 8 is a schematic side perspective exploded view of the patient lifting device of FIG. 7;

FIG. 9 is a schematic end perspective sectional view of the patient lifting device of FIG. 7;

FIG. 10A is a schematic sectional side view of the patient lifting device of FIG. 7 in use in a patient lifting operation;

FIG. 10B is a schematic sectional side view of the patient lifting device of FIG. 7 in use at a subsequent step in a patient lifting operation;

FIG. 11A is a schematic sectional side view of the patient lifting device of FIG. 7 in use at a subsequent step in a patient lifting operation;

FIG. 11B is a schematic sectional side view of the patient lifting device of FIG. 7 in use at a subsequent step in a patient lifting operation;

FIG. 12 is a schematic sectional side view of the patient lifting device of FIG. 7 in use at a subsequent step in a patient lifting operation;

FIG. 13 is a schematic sectional side view of the patient lifting device of FIG. 7 in use at a subsequent step in a patient lifting operation; and

FIG. 14 is a schematic perspective view of another version of a patient lifting device of the invention.

### DESCRIPTION

The present invention relates to a patient lifting device. In particular, the invention relates to a pneumatic patient lifting device that is inflated by blown and/or pressurized air. Although the invention is illustrated and described in the context of being useful for lifting a fallen patient to a desire height, the present invention can be used in other ways, as would be readily apparent to those of ordinary skill in the art.

Accordingly, the present invention should not be limited just to the examples and embodiments described herein.

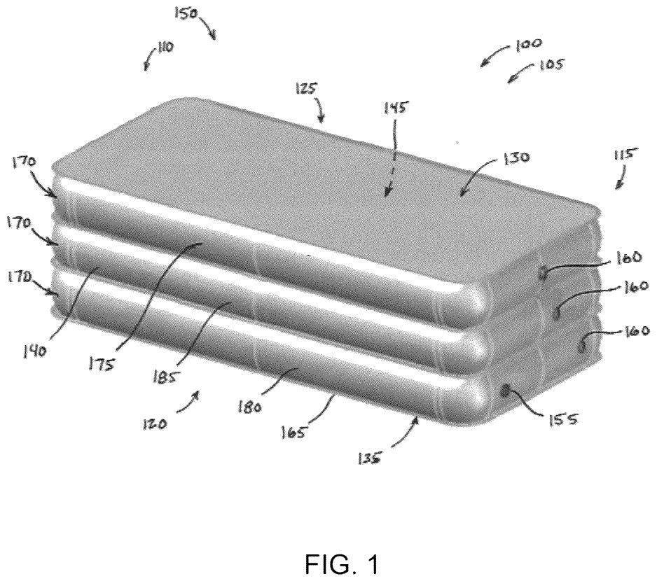

FIG. 1 shows a patient lifting device 100 of the invention. The patient lifting device of FIG. 1 operates pneumatically by being inflated by blown and/or pressurized air from an air supply. The patient lifting device 100 has a body 105 made of a flexible and airtight material. The body 105 extends longitudinally from a first end 110 to a second end 115 and laterally or transversely from a right side 120 to a left side 125 relative to a patient lying on his or her back on the patient lifting device 100. The patient lifting device 100 is designed and equipped to lift a patient in need thereof, such as by lifting a patient in a supine position with the patient's head positioned near the first end 110 and the patient's feet positioned near the second end 115 or vice versa. The body 105 of the patient lifting device 100 includes a top surface 130 adapted to receive or support the patient that is to be lifted and a bottom surface 135 adapted to contact a floor, ground, or other surface that the patient is to be lifted from. The top surface 130 and the bottom surface 135 are connected by a flexible sidewall 140. The body 115 includes a pneumatic lifting system 145 that is inflatable to the inflated condition 150 of the patient lifting device 100 as shown in FIG. 1. By being inflated, the pneumatic lifting system 145 moves the top surface 130 upward and away from the bottom surface 135 so that a patient positioned on the top surface 130 is lifted from the surface on which the bottom surface 135 is placed. An air inlet 155 provides air access to the interior space 110 so that blowing and/or pressurized air from an air supply can be introduced through the air inlet 155 to cause the patient lifting device 100 to be inflated, as will be described in more detail. In one version, the air inlet 155 is a one-way valve that only allows air to flow into the interior space 110. Alternatively, the air inlet 155 can be an opening that is closeable when it is desired to keep air in the interior space 110 from escaping. The body 105 also includes one or more deflation openings 160 that can be selectively opened to allow air in the interior space 110 to escape and thus allows the patient lifting device 100 to be deflated. The deflation openings 160 can optionally be one-way valves that only allow the escape of air when opened.

When the patient lifting device 100 is deflated, the pneumatic lifting system 145 is deflated and the patient lifting device 100 lies substantially flat with the flexible sidewall 140 substantially collapsed and the top surface 130 lowered to be in proximity to the bottom surface 135 with little or no air or space therebetween. The deflated patient lifting device 100 is then laid out next to the patient who is to be lifted, and the patient is rolled, slid, and/or otherwise manipulated onto the patient lifting device 100 so that the patient's body is positioned atop the top surface 130 in a generally centered fashion. An air supply is then connected to the air inlet 115 and the interior space 110 is filled with air with the one or more deflation openings 120 closed so that the air is retained within the pneumatic lifting system 145. The air fills the pneumatic lifting system 145 in airtight manner and causes the patient lifting device 100 to inflate which causes the top surface 130 to be moved away from the bottom surface 135 on the floor or other surface. By continuing to introduce air through the air inlet 155 and into the pneumatic lifting system 145, the patient lifting device 100 can be fully inflated to its inflated condition 150 shown in FIG. 1, and the patient can be lifted to the height of the top surface 130 in the inflated condition 150. Once lifted to the desired height, the patient can be easily transferred to another object, such as a bed, gurney, or the like. The transfer can be performed by rolling, sliding, and/or gentle lifting with or without the assistance of the patient. Optionally, a transfer mattress, such as a PPS Glide transfer mattress available for Patent Positioning Services of Annapolis, MD can be used.

The patient lifting device 100 can thus simply and conveniently be used to lift a patient from a floor or other surface to a desired height without undue stress or effort on the part of a caregiver. By patient it is meant any person or other animal who is in need of being lifted. Often this will be a person who has fallen or is otherwise on the floor or ground and who has difficulty standing on their own. A caregiver can be anyone responsible for the care of the patient and/or otherwise interested in assisting the patient to get off the floor. For example, the caregiver can be a friend or family member and/or a medical practitioner, such as a nurse, physician, or emergency technician. The patient lifting device 100 is portable and can be used indoor, such as in a home, hospice, or healthcare facility or outdoor, such as at an accident site or on a sidewalk. The desired height can be any height that it is desired to lift the patient. For example, it is often desirable to lift a patient to a height of about 30 to 35 inches where the patient can be easily transferred to a bed, sofa, gurney, and/or the like, but the patient lifting device 100 can be designed to lift a patient to a higher or lower height. The patient lifting device 100 can also be used to lift other objects if desired. The bottom surface 135 can be a surface on a layer of reinforced material 165 designed to be useable on an outdoor surface and/or be dragged across the ground without becoming punctured. In one version, the layer of reinforced material 165 is more durable and/or less flexible than the sidewall 140. The layer of reinforced material 165 can be a separate layer that is connected to a bottom of the body 105 or can be the incorporated into the bottom of the body 105. The top surface 130 can be adapted to receive the patient, such as by being made of antimicrobial material, easily washable and/or sterilizable material, and/or able to receive a replaceable sheet or other material.

As can be seen in FIG. 1, in one version of the patient lifting device 100 of the invention, the pneumatic lifting system 145 of the body 105 of the patient lifting device 100 comprises a plurality of vertical layers 170 with each vertical layer 170 having and/or defining an air chamber that is separated from the air chamber of an adjacent vertical layer 170, as will be described. The air chambers of the vertical layers 170 are part of the interior space 145. In the version of FIG. 1, the body 105 of the patient lifting device 100 comprises a top vertical layer 175 that includes or supports the top surface 130 of the patient lifting device 100 and a bottom vertical layer 180 that includes, is connected to, or is connectable to the bottom surface 135 and/or the layer of reinforced material 165. In one version, the bottom layer 180 includes a bottom that is made up of the layer of reinforced material 165. Sandwiched between the top vertical layer 175 and the bottom vertical layer 180 is an intermediate vertical layer 185. In the version of FIG. 1, the intermediate vertical layer 185 is positioned with its top adjacent to and/or forming a part of the top vertical layer 175 and with its bottom adjacent to and/or forming a part of the bottom vertical layer 180.

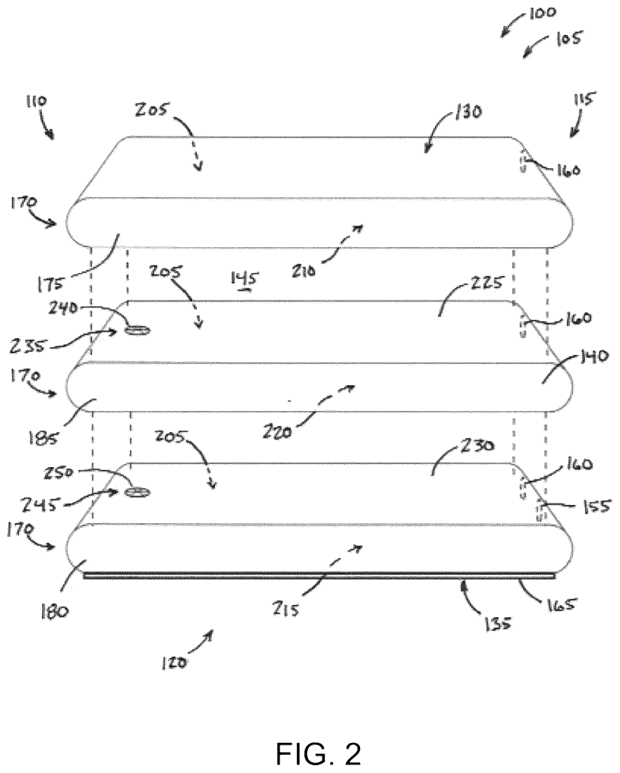

FIG. 2 shows an exploded or disassembled view of the patient lifting device 100 of FIG. 1. The exploded view of FIG. 2 is provided for visualizing the parts of the patient lifting device 100 and is not meant to necessarily suggest the parts can be separated or disassembled as shown. As can be seen, each vertical layer 170 contains an air compartment 205. The top vertical layer 170 contains a top vertical layer air compartment 210, the bottom vertical layer 180 includes a bottom vertical layer air compartment 215, and the intermediate vertical layer 185 includes an intermediate vertical layer air compartment 220. An upper internal barrier 225 separates the top vertical layer air compartment 210 from the intermediate layer air compartment 220, and a lower internal barrier 230 separates the bottom vertical layer air compartment 215 from the intermediate vertical layer air compartment 220. The upper internal barrier 225 and the lower internal barrier 230 can be made of an airtight flexible material, such as the same material as the sidewall 140. An upper barrier valving system 235 is provided on the upper internal barrier 225. The upper barrier valving system 235 comprises one or more upper barrier valves 240. The one or more upper barrier valves 240 allow air to flow from the intermediate vertical layer air compartment 220 to the top vertical layer air compartment 210 under certain conditions, as will be explained. A lower barrier valving system 245 is provided on the lower internal barrier 230. The lower barrier valving system 245 comprises one or more lower barrier valves 250. The one or more lower barrier valves 250 allow air to flow from the bottom vertical layer air compartment 215 to the intermediate vertical layer air compartment 220 under certain conditions as will be explained.

During inflation of the patient lifting device 100, air is blown or otherwise introduced into the air inlet 155 which is located in the bottom vertical layer 180. In the version shown, the air inlet 155 is positioned on the second end 115 of the patient lifting device 100, but it can be otherwise positioned, such as on the first end 110 or on the right side 120 or left side 125. Air fills the bottom vertical layer air compartment 215. When the air pressure within the bottom vertical layer air compartment 180 reaches a certain level, air flows through the one or more lower barrier valves 250, and the intermediate vertical layer air compartment 220 begins filling with air. When the air pressure within the intermediate vertical layer air compartment 220 reaches a certain level, air flows through the one or more upper barrier valves 240, and the top vertical layer air compartment 210 begins filling with air. When the top vertical layer air compartment 210 is filled, the patient lifting device 100 will be in its inflated condition 150, as shown in FIG. 1, and the patient will be lifted to a desired height. Once inflated, the air supply can be turned off and/or disconnected from the air inlet 155, if desired. Optionally, a valve can be provided on the top vertical layer that is adapted to release air to prevent over inflation. To deflate the patient lifting device 100, a deflation opening 160, such as the deflation opening 160 in the top vertical layer can be opened so the air within the top vertical layer air compartment 210 can escape and then air from the intermediate vertical layer air compartment 220 and the bottom vertical layer air compartment 215 will flow out the deflation opening 160. To increase the rate of deflation, pressure can be applied to the patient lifting device 100, such as by sitting or lying on the device. In addition, the rate of deflation can be increased by providing and opening additional deflation openings 160, such as by having a deflation opening on each vertical layer 170, as shown in the version of FIGS. 1 and 2.

The use of a single air inlet 155 to fill each of the vertical layer 170 offers several advantages over existing systems which have closed air compartments that each have their own air inlet and that must be filled separately and sequentially. For example, there is a significant reduction in time and effort associated with connecting an air supply to the air inlet only one time. With existing systems, a caregiver must connect an air supply to a first compartment, wait for the first compartment to fill, detach the air supply and attach it to a second compartment air inlet, wait for the second compartment to fill, and so on until the lift and the patient reaches a desired height. In addition, with the patient lifting device 100 of the invention, a cradling effect is achieved during the lifting of the patient. As will be described in more detail below, because of the patient's weight and the flexibility of the materials that make up the sidewall 140 and the vertical layers 170, the filling of the air compartments first happens around the sides of the patient. This cradles the patient between the filling sides and helps prevent the patient from rolling off the top surface 130. Without the single air inlet 155 that fills multiple air compartments 170, the cradling effect would not occur throughout the lifting process.

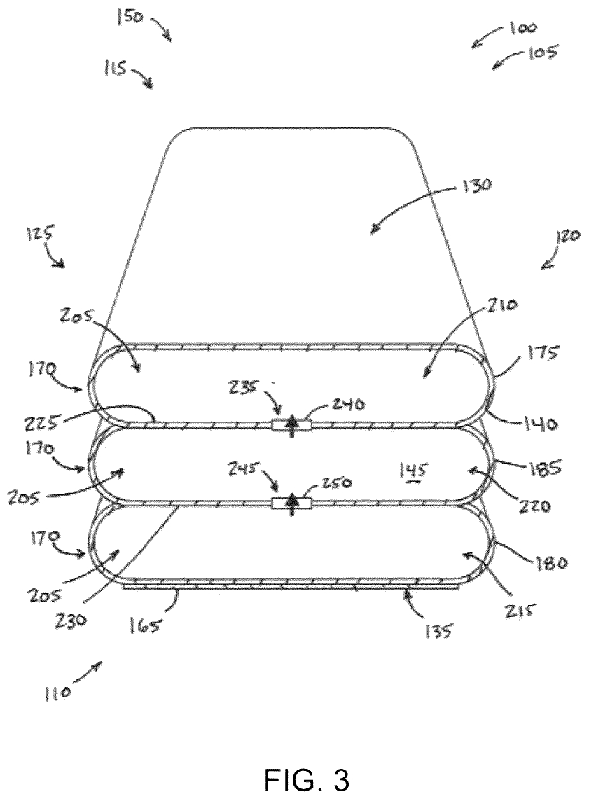

FIG. 3 shows a transverse sectional view of the patient lifting device 100 of FIGS. 1 and 2 as viewed from the first end 110 with the section taken through the patient lifting device 100 at the location of the upper barrier valving system 235 and the lower barrier valving system 245. As can be seen, in this version of the patient lifting device 100, the bottom vertical layer air compartment 215, the top vertical layer air compartment 210, and the intermediate vertical layer air compartment 220 are open compartments. By open compartment it is meant that each air compartment 205 is substantially unobstructed. For example, each of the air compartments 205 lacks any baffles, structures, or channels that are used to direct the flow of air within an air compartment 205. Instead, the open compartments are air compartments 205 with open spaces that extend from the first end 110 to the second end 115 and from the right side 120 to the left side 125. By having these open compartments, the patient lifting device 100 of FIG. 3 offers several design advantages. For example, the open compartments allow the patient lifting system 100 to inflate to its inflated condition 150 in less time than if one or more of the air compartments had baffles or the like that hinder the flow of air. Deflation time is also reduced. In addition, the lack of structures within the air compartments allows the patient lifting device to collapse when deflated to a flatter position than if structures where present within the air compartments. This makes it easier and more convenient to position a fallen patient on the top surface 130 of the deflated patient lifting device 100. Furthermore, the lack of air directing structures within the air compartments, allows air to move more easily to the peripheries to further facilitate the cradling effect mentioned above and elaborated on below.

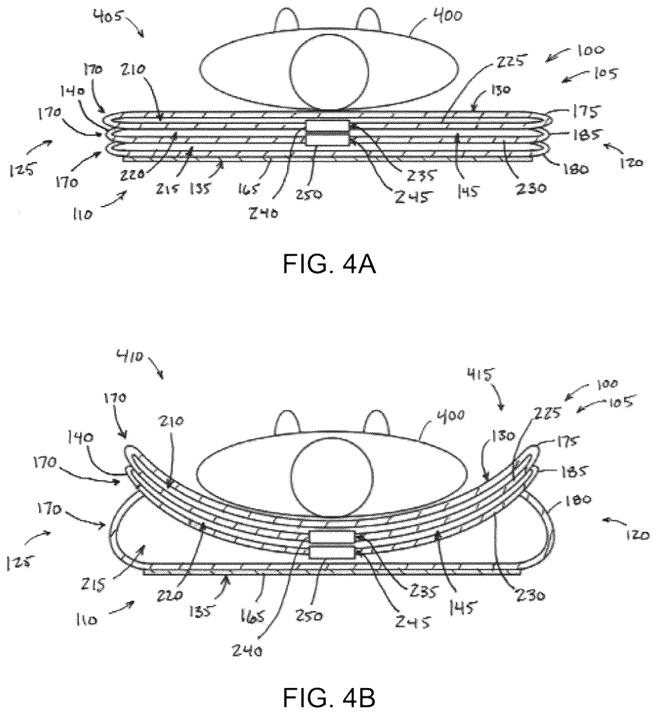

The design of the patient lifting device 100 and particularly the design of the pneumatic lifting system 145 within the patient lifting device 100, including the placement of parts and the characteristics of the materials used, is selected to provide certain advantageous lifting performance features. For example, the patient lifting device 100 can be designed to provide improved lateral stability for a patient being lifted by the patient lifting device 100. This feature is illustrated by FIGS. 4A, 4B, 5A, 5B, 6A, and 6B which show sequential sectional end views from the first end 110 of the operation of the patient lifting device 100 while lifting a patient who has fallen and is in need of lifting. A schematic representation of the patient 400 is shows the patient's head positioned at the first end 110 and the patient's feet at the second end 115 of the patient lifting device 100.

FIG. 4A shows the patient lifting device 100 in a deflated condition 405. In the deflated condition, most or substantially all of the air has been removed from the air compartments 205 so the patient lifting device 100 can lie in a collapsed, substantially flat condition. The patient lifting device can lie flatter than is shown in FIG. 4A but is shown out of scale in this regard to be able to more clearly illustrate the operation. A patient who has fallen or otherwise needs to be lifted is positioned on the top surface 130 of the patient lifting device 100 in its deflated condition 405. This positioning can be accomplished by rolling, sliding, and/or gently lifting the patient onto the collapsed patient lifting device 100 and/or by scrunching and manipulating the patient lifting device 100 under the patient 400. The patient lifting device 100 is now in a ready to lift condition, and a caregiver can at this point connect the air inlet 155 to an air supply or start operation of the air supply if previously connected.

FIG. 4B shows the patient lifting device 100 at the initial stages of an inflating condition 410. As blown and/or pressurized air from an air supply enters the air inlet 155, the bottom vertical layer air compartment 215 begins to fill with air. Because of the flexibility of the materials that define at least a portion of the bottom vertical layer 180 and because of the weight of the patient, the air in the bottom vertical layer air compartment 215 first fills along the peripheries of the bottom vertical layer air compartment 215 and particularly to the right side and left side of the patient 400. This creates a cradling condition 415 which provides a cradling effect that helps provide lateral stability for the patient 400 that helps prevent the patient from movement to the right side 120 or left side 125. This cradling effect can both help prevent a patient from falling laterally off the patient lifting device 100 and can help prevent the patient from feeling as if they might fall which can provide calming reassurance to the patient during the lifting process. By cradling condition it is meant that air within the pneumatic lifting system 145 of the patient lifting device 100 causes the top surface 130 to the right side 120 and/or left side 125 to be at a noticeably higher elevation than the elevation of the top surface 130 that is supporting the patient's weight and in particular that is under the patient's center of gravity. By cradling effect it is meant the effect the cradling condition 415 has on the patient, such as the provision of a cushioned obstruction to the side of the patient 400 that helps to prevent the patient 400 from rolling or sliding to the edge of the patient lifting device 100. The cradling effect can be provided even if the heightened portion of the top surface 160 is not actually contacting the patient 400 during the lifting process.

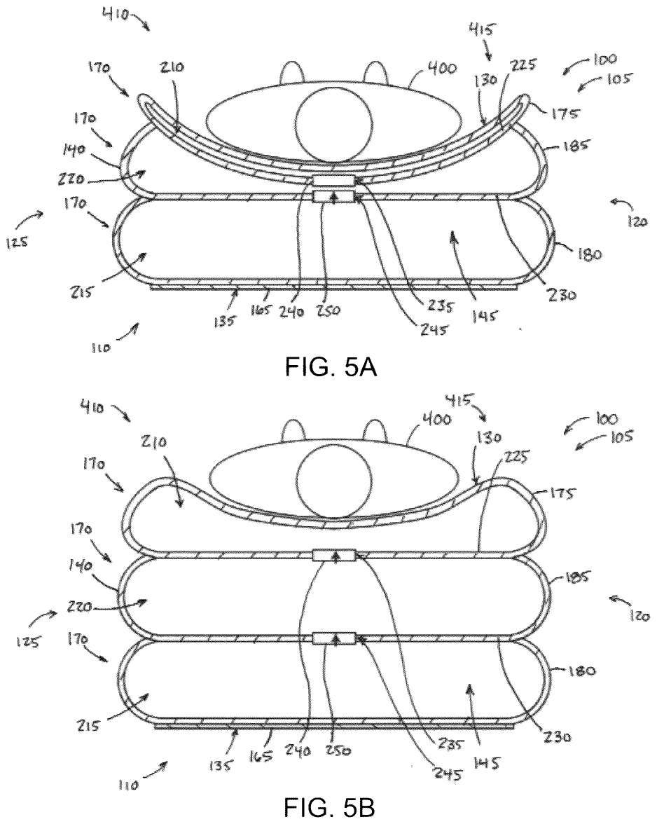

FIG. 5A shows a subsequent stage of the patient lifting process using the patient lifting device 100. As can be seen, in the inflating condition 410 of FIG. 5A, the bottom vertical layer air compartment 215 has become filled or mostly filled, and air is passing through the one or more lower barrier valves 250 of the lower barrier valving system 245. As air is beginning to fill the intermediate vertical layer air compartment 220, the weight of the patient 400 again directs the air towards the peripheries and in particular towards the right side 120 and left side 125 so that the intermediate vertical layer air compartment 220 is filled in a manner that elevates the sides of the top surface 130 in a way that creates a cradling condition. The lower barrier valving system 245 can be designed to allow air to flow from the bottom vertical layer air compartment 215 to the intermediate vertical layer air compartment 220 at any stage or pressure during the filling of the bottom vertical layer air chamber 215. For example, air can begin to pass through the one or more lower barrier valves 250 when the bottom vertical air compartment 215 is about 25 percent, about 50 percent, about 60 percent, about 70 percent, about 80 percent, about 90 percent, about 95 percent, or about 100 percent filled, where percent filled can be in terms of volume or pressure. The percent fill when the air begins to noticeably flow will depend on the weight of the patient, and the above percentages can be determined when no patient is on the top surface. In another version, the percentages are for an average weight man or woman or for a 200 pound person. In one version, air is permitted to flow through the lower barrier valving system 245 when the bottom vertical layer air compartment 215 is mostly filled but before the bottom vertical layer air compartment 215 is completely filled, such as by being designed for the valve to crack and permit air to flow at a pressure when the bottom vertical layer air compartment 215 is from about 60 percent to about 99 percent filled or from about 80 percent to about 98 percent filled. With these ranges, the intermediate vertical layer air compartment 220 serves to establish or maintain the cradling condition 415 before the bottom vertical layer air compartment 215 is completely or 100% filled while still allowing the bottom vertical layer air compartment 215 to mostly fill before the intermediate vertical layer air compartment 220 begins to substantially fill, which allows for a generally sequential fill and a gentle lift. This allows the cradling condition 415 to be maintained throughout the transition of filling of the bottom vertical layer air compartment 215 and the intermediate vertical layer air compartment 220 while also maintaining stability by mostly filling from the bottom up.

FIG. 5B shows a subsequent stage of the patient lifting process using the patient lifting device 100 following the stage of FIG. 5A. As can be seen, in the inflating condition 410 of FIG. 5B, the intermediate vertical layer air compartment 220 has become filled or mostly filled, and air is passing through the one or more upper barrier valves 240 of the upper barrier valving system 235. As air is beginning to fill the top vertical layer air compartment 210, the weight of the patient 400 again directs the air towards the peripheries and in particular towards the right side 120 and left side 125 so that the top vertical layer air compartment 210 is filled in a manner that elevates the sides of the top surface 130 in a way that creates a cradling condition. The upper barrier valving system 235 can be designed to allow air to flow from the intermediate vertical layer air compartment 220 to the top vertical layer air compartment 210 at any stage or pressure during the filling of the intermediate vertical layer air chamber 220. For example, air can begin to pass through the one or more upper barrier valves 240 when the intermediate vertical air compartment 220 is about 25 percent, about 50 percent, about 60 percent, about 70 percent, about 80 percent, about 90 percent, about 95 percent, or about 100 percent filled, where percent filled can be in terms of volume or pressure. The percent fill when the air begins to noticeably flow will depend on the weight of the patient, and the above percentages can be determined when no patient is on the top surface. In another version, the percentages are for an average weight man or woman or for a 200 pound person. In one version, air is permitted to flow through the upper barrier valving system 235 when the intermediate vertical layer air compartment 220 is mostly filled but before the intermediate vertical layer air compartment 220 is completely filled, such as by being designed for the valve to crack and permit air to flow at a pressure when the intermediate vertical layer air compartment 220 is from about 60 percent to about 99 percent filled or from about 80 percent to about 98 percent filled. With these ranges, the top vertical layer air compartment 210 serves to establish or maintain the cradling condition 415 before the intermediate vertical layer air compartment 220 is completely or 100% filled while still allowing the intermediate layer air compartment 220 to mostly fill before the top layer air compartment 210 begins to substantially fill, which allows for a generally sequential fill and a gentle lift. This allows the cradling condition 415 to be maintained throughout the transition of filling of the intermediate vertical layer air compartment 220 and the top vertical layer air compartment 210 while also maintaining stability by mostly filling from the bottom up. In one version, the upper barrier valving system 235 and the lower barrier valving system 245 are designed to crack and allow air to flow about the same fill percentages and/or air pressures. Alternatively, the valve systems can be different from one another to provide a particularly tailored lifting process. In one version, the valving systems can be designed so that air is allowed to flow so that the bottom vertical layer air compartment 215, the intermediate vertical layer air compartment 220, and the top vertical layer air compartment 210 are being filled at the same time, but in a preferred version, the bottom vertical layer air compartment 215 will fill first to near but not complete fill, then the intermediate vertical layer air compartment 220 will fill to near but not complete fill, then the top vertical layer air compartment 210 will fill completely along with complete filling of the other compartments.

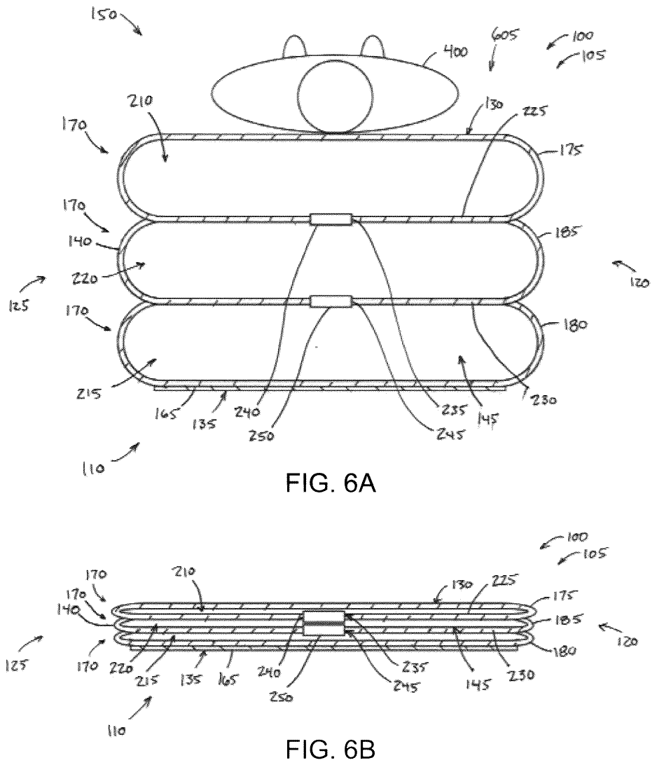

FIG. 6A shows the patient lifting device 100 in an inflated condition 150 with the filling of top vertical layer air compartment 210 being completed following continued filling from the condition shown in FIG. 5B. In the inflated condition 150, the air supply can be shut off or disconnected so that no more air flows into the pneumatic lifting system 145. As the top vertical layer air compartment 210 reaches its fully filled condition, the cradling condition subsides and the top surface 130 becomes more level. In this uncradling condition 605 with the leveled top surface 130, the patient can be easily transferred to another object such as a bed, gurney, wheelchair, or the like, as discussed above. After the patient has been transferred off the patient lifting device 100, one or more of the deflation openings 160 can be opened and the air within the air compartments 205 can be allowed to escape so that the patient lifting device 100 returns to its deflated condition 405 as shown in FIG. 6B where it can be stored and/or used again to lift a patient.

An additional advantageous lifting performance feature provided by the patient lifting device 100 includes providing improved elevational positioning of the patient along the length of the patient lifting device during a lifting process. As can be seen, for example, in FIG. 2, in one version of the patient lifting device 100, the upper barrier valving system 235 and/or the lower barrier valving system 245, preferably both, are provided in the first end 110 of the body 105 of the patient lifting device 100, and preferably with no valving systems provided away from the first end. By providing the valving systems in the first end, the filling of the air compartments 205 occurs in a manner that helps to prevent the level of the head area of the patient from falling below the level of the rest of the patient's body. In some situations, it may be desirable to make sure the feet of the patient stay elevated relative to the rest of the patient's body. In such cases, the patient can be positioned on the top surface 130 with the patient's feet on the end with the valving systems or the patient lifting device 100 can be constructed with the valving systems on the second end 125.

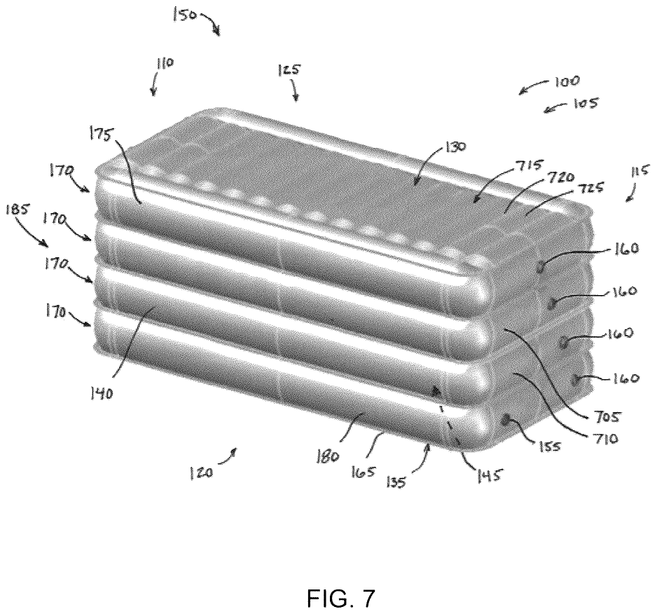

FIG. 7 shows another version of a patient lifting device 100 of the invention. In the version of FIG. 7, the intermediate vertical layer 185 comprises a first intermediate vertical layer 705 and a second intermediate vertical layer 710. Accordingly, in the version of FIG. 7, the patient lifting device 100 comprises four vertical layers 170, the top vertical layer 175, the bottom vertical layer 180, the first intermediate layer 705, and the second intermediate layer 710. Optionally, the intermediate vertical layer 185 can comprise one or more additional vertical layers 170.

Another feature shown in the version of FIG. 7, which is also applicable to the version of FIG. 1, is a top surface rigidifying structure 715 on the top surface 130 of the body 105 of the patient lifting device 100. The top surface rigidifying structure 715 is on or forms a part of the top surface 130 at the position where a patient can lie on the top surface rigidifying structure 715. The top surface rigidifying structure 715 is any structural arrangement or material that makes the portion of the top surface 130 that contains the top surface rigidifying structure 715 more rigid than the other portions of the top surface 130 and/or the sidewall 140. While the top surface rigidifying structure 715 can still be flexible, it is less flexible than the other portions of the top surface 130 and/or the sidewall 140. The top surface rigidifying structure 715 can be provided in any suitable manner, such as by using a material with increased rigidity or by using the same material as the rest of the top surface 130 and/or sidewall 140 but in a thicker application. In the particular version shown, the top surface rigidifying structure 715 is provided by a series of horizontal and lateral seams 720 and/or ridges 725 that are designed to help prevent the outward flexion of the top surface 130 in the area of the top surface rigidifying structure 715. The top surface rigidifying structure 715 serves several purposes. For example, the top surface rigidifying structure helps prevent undesired upward ballooning of the top surface 130 during inflation. Also, when properly positioned, the top surface rigidifying structure 715 can help encourage the cradling effect, as will be described in more detail below. In addition, as will also be described below, the top surface rigidifying structure 715 can help prevent a patient from being squeezed on the sides by the cradling effect during the lifting process. Additionally or alternatively, a rigidifying structure similar to the top surface rigidifying structure 715 can be provided at a different location on the patient lifting device 100.

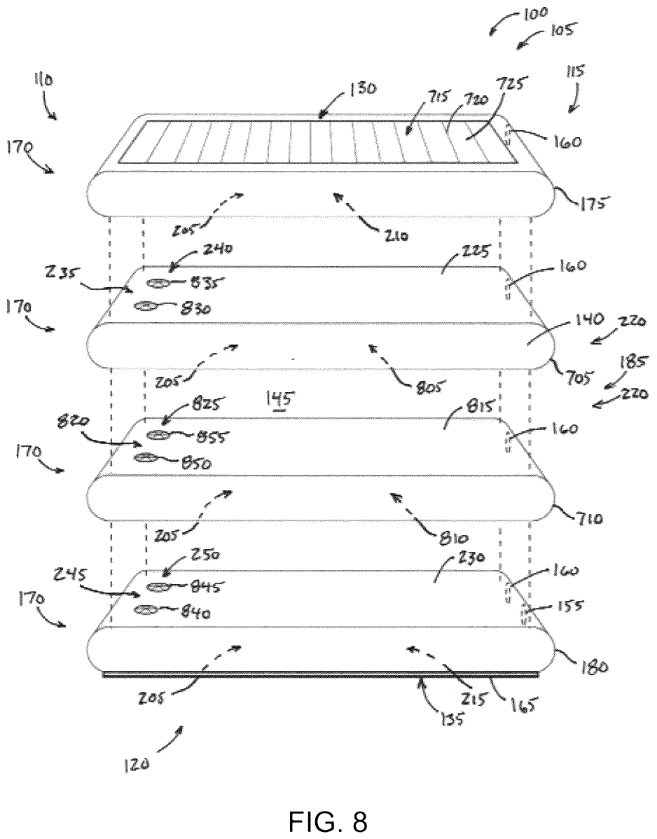

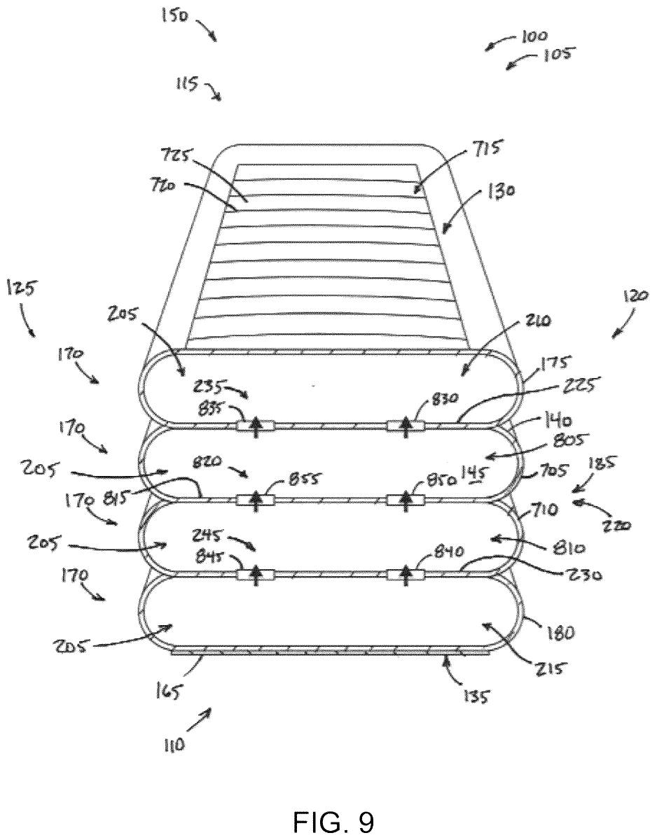

FIG. 8 shows an exploded or disassembled view of the patient lifting device 100 of FIG. 7. FIG. 9 shows a transverse sectional view of the patient lifting device 100 of FIGS. 7 and 8 as viewed from the first end 110. As can be seen, the first intermediate vertical layer 705 is adjacent the top vertical layer 175 and has a first intermediate layer vertical air compartment 805 that is separated from the top vertical layer air compartment 210 by the upper internal barrier 225. The second intermediate vertical layer 710 is adjacent the bottom vertical layer 180 and has a second intermediate layer vertical air compartment 810 that is separated from the bottom vertical layer air compartment 215 by the lower internal barrier 230. An intermediate internal barrier 815 separates the first intermediate vertical layer air compartment 805 from the second intermediate vertical layer air compartment 810. An intermediate barrier valving system 820 comprising one or more intermediate barrier valves 825 is provided on the intermediate barrier 815. The intermediate barrier valving system 820 operates in similar manner as upper barrier valving system 235 and/or lower barrier valving system 245.

In addition, the version of the patient lifting device 100 shown in FIGS. 7, 8, and 9 has additional features that are useful and advantageous with regard to the cradling effect created during the lifting process which are also applicable to the version of FIG. 1. For example, as can be seen in FIGS. 8 and 9, in this version, the upper barrier valving system 235 comprises a right side upper barrier valve 830 and a left side upper barrier valve 835. The lower barrier valving system 245 comprised a right side lower barrier valve 840 and a left side lower barrier valve 845. The intermediate barrier valving system 820 comprises a right side intermediate valve 850 and a left side intermediate valve 855. The pairs of valves positioned on opposite sides of the patient lifting device 100 allows air to be more easily and/or more evenly directed towards the peripheries of the intermediate vertical layer air compartment 220 and the top vertical layer air compartment 210 so that the cradling configuration can be achieved more efficiently and/or more effectively. In addition, the pair of valves on opposite sides of the patient lifting device 100 provides less obstructed flow during the filling process. This is particularly advantageous when the valving systems are located in proximity to the position where a patient's head will rest. By being moved away from the center, the weight of the patient's head is less likely to press against he valve and thus there is a reduced restriction of flow in proximity to the valving systems.

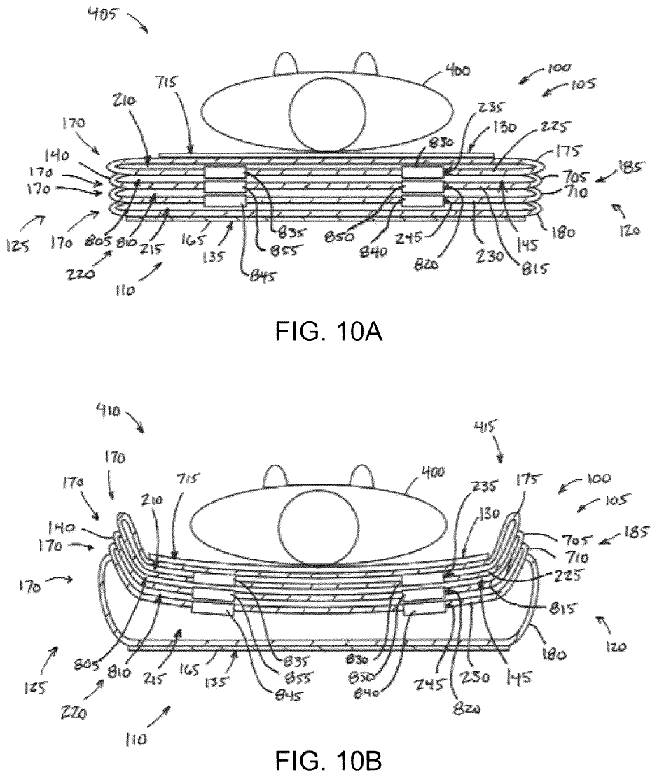

FIGS. 10A, 10B, 11A, 11B, 12, and 13 illustrate the operation of the version of the patient lifting device 100 of FIGS. 7, 8, and 9. FIGS. 10A, 10B, 11A, 11B, 12, and 13 show sequential sectional end views from the first end 110 of the operation of the patient lifting device 100 of FIGS. 7, 8, and 9 while lifting a patient who has fallen and is in need of lifting.

FIG. 10A shows the patient lifting device 100 in a deflated condition 405. In the deflated condition, most or substantially all of the air has been removed from the air compartments 205 so the patient lifting device 100 can lie in a collapsed, substantially flat condition. The patient lifting device can lie flatter than is shown in FIG. 4A but is shown out of scale in this regard to be able to more clearly illustrate the operation. A patient who has fallen or otherwise needs to be lifted is positioned on the top surface 130 of the patient lifting device 100 in its deflated condition 405. This positioning can be accomplished by rolling, sliding, and/or gently lifting the patient onto the collapsed patient lifting device 100 and/or by scrunching and manipulating the patient lifting device 100 under the patient 400. In the version shown, the patient 400 is positioned on the top surface rigidifying structure 715 that is on or a part of the top surface 130. The patient lifting device 100 is now in a ready to lift condition, and a caregiver can at this point connect the air inlet 155 to an air supply or start operation of the air supply if previously connected.

FIG. 10B shows the patient lifting device 100 at the initial stages of an inflating condition 410. As blown and/or pressurized air from an air supply enters the air inlet 155, the bottom vertical layer air compartment 215 begins to fill with air. Because of the flexibility of the materials that define at least a portion of the bottom vertical layer 180, because of the weight of the patient, and because of the relative rigidity of the top surface rigidifying structure 715, the air in the bottom vertical layer air compartment 215 first fills along the peripheries of the bottom vertical layer air compartment 215 and particularly to the right side and left side of the patient 400. This creates the cradling condition 415 which provides the cradling effect that helps provide lateral stability for the patient 400 that helps prevent the patient from movement to the right side 120 or left side 125. This cradling effect can both help prevent a patient from falling laterally off the patient lifting device 100 and can help prevent the patient from feeling as if they might fall which can provide calming reassurance to the patient during the lifting process, as discussed above. As can be seen, due to the relative rigidity of the top surface rigidifying structure 715, in this version, the cradling effect can be provided without or with reduced side pressure being applied to the patient 400. The cradling effect can be provided even if the heightened portion of the top surface 160 is not actually contacting the patient 400 during the lifting process. This can provide a more comfortable lifting experience for the patient while still providing the cradling effect guard rails that help prevent rolling off the patient lifting device 100 and/or that provide protective reassurance to the patient.

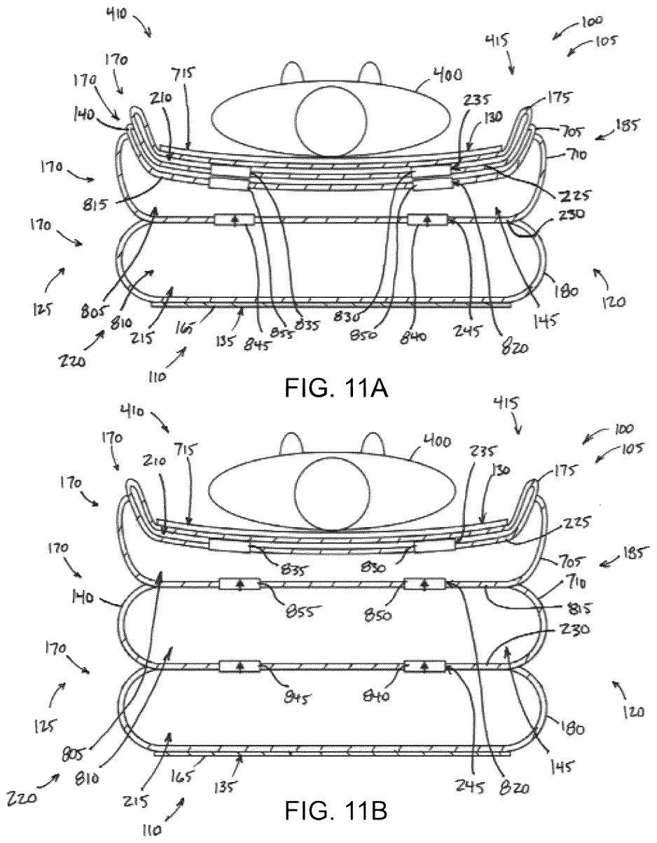

FIG. 11A shows a subsequent stage of the patient lifting process using the patient lifting device 100. As can be seen, in the inflating condition 410 of FIG. 11A, the bottom vertical layer air compartment 215 has become filled or mostly filled, and air is passing through the right side lower barrier valve 840 and the left side lower barrier valve 845. As air is beginning to fill the second intermediate vertical layer air compartment 810, the weight of the patient 400 and the relative rigidity of the top surface rigidifying structure 715 again directs the air towards the peripheries and in particular towards the right side 120 and left side 125 so that the intermediate vertical layer air compartment 220 is filled in a manner that elevates the sides of the top surface 130 in a way that creates the cradling condition. As can be seen, because of the side positioning of the right side lower barrier valve 840 and the left side lower barrier valve 845 pair, the valves are not directly below the head of the patient 400 and are off to the side where there is no or less weight above them thus providing air to flow in a less restricted manner around and through the valves. In addition, the side positioning allows the right side lower barrier valve 840 to be positioned in closer proximity to the right side elevation of the cradling condition expansion and the left side lower barrier valve 845 to be positioned in closer proximity to the left side cradling condition expansion. This allows the side peripheries to elevate to their cradling condition easier and/or more evenly. The lower barrier valving system 245 can be designed to allow air to flow from the bottom vertical layer air compartment 215 to the intermediate vertical layer air compartment 220 at any stage or pressure during the filling of the bottom vertical layer air chamber 215, as discussed above.

FIG. 11B shows a subsequent stage of the patient lifting process using the patient lifting device 100 following the stage of FIG. 11A. As can be seen, in the inflating condition 410 of FIG. 11B, the second intermediate vertical layer air compartment 810 has become filled or mostly filled, and air is passing through the right side intermediate barrier valve 850 and the left side intermediate barrier valve 855 of the intermediate barrier valving system 820. As air is beginning to fill the first intermediate vertical layer air compartment 805, the weight of the patient 400, the relative rigidity of the top surface rigidifying structure 715, and the side placement of the valve pair again direct the air towards the peripheries and in particular towards the right side 120 and left side 125 so that the first intermediate vertical layer air compartment 805 is filled in a manner that elevates the sides of the top surface 130 in a way that creates the cradling condition. The intermediate barrier valving system 820 can be designed to allow air to flow from the second intermediate vertical layer air compartment 810 to the first intermediate vertical layer air compartment 805 at any stage or pressure during the filling of the second intermediate vertical layer air chamber 810.

For example, air can begin to pass through the intermediate barrier valving system 820, such as the one or more intermediate barrier valves 825, when the second intermediate vertical air compartment 810 is about 25 percent, about 50 percent, about 60 percent, about 70 percent, about 80 percent, about 90 percent, about 95 percent, or about 100 percent filled, where percent filled can be in terms of volume or pressure. The percent fill when the air begins to noticeably flow will depend on the weight of the patient, and the above percentages can be determined when no patient is on the top surface. In another version, the percentages are for an average weight man or woman or for a 200 pound person. In one version, air is permitted to flow through the intermediate barrier valving system 820 when the second intermediate vertical layer air compartment 810 is mostly filled but before the second intermediate vertical layer air compartment 810 is completely filled, such as by being designed for the valve to crack and permit air to flow at a pressure when the second intermediate vertical layer air compartment 810 is from about 60 percent to about 99 percent filled or from about 80 percent to about 98 percent filled. With these ranges, the first intermediate vertical layer air compartment 805 serves to establish or maintain the cradling condition 415 before the second intermediate vertical layer air compartment 810 is completely or 100% filled while still allowing the second intermediate layer air compartment 810 to mostly fill before the first intermediate vertical layer air compartment 805 begins to substantially fill, which allows for a generally sequential fill and a gentle lift. This allows the cradling condition 415 to be maintained throughout the transition of filling of the second intermediate vertical layer air compartment 810 and the first intermediate vertical layer air compartment 805 while also maintaining stability by mostly filling from the bottom up. In one version, the intermediate barrier valving system 820, the upper barrier valving system 235, and the lower barrier valving system 245 are designed to crack and allow air to flow about the same fill percentages and/or air pressures. Alternatively, the valve systems can be different from one another to provide a particularly tailored lifting process. In one version, the valving systems can be designed so that air is allowed to flow so that the bottom vertical layer air compartment 215, the second intermediate vertical layer air compartment 810, the first intermediate vertical layer air compartment 805, and the top vertical layer air compartment 210 are being filled at the same time, but in a preferred version, the bottom vertical layer air compartment 215 will fill first to near but not complete fill, then the second intermediate vertical layer air compartment 810 will fill to near but not complete fill, then the second intermediate vertical layer air compartment 805 will fill to near but not complete fill, then the top vertical layer air compartment 210 will fill completely along with complete filling of the other compartments.

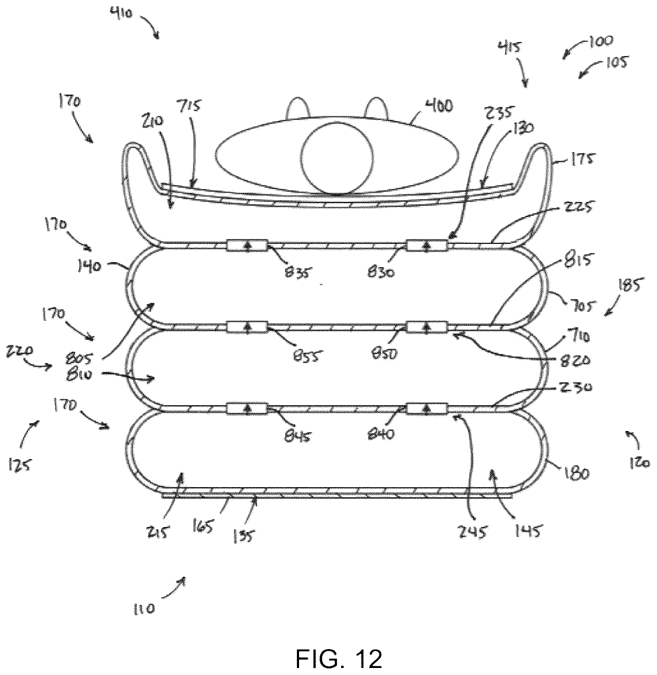

FIG. 12 shows a subsequent stage of the patient lifting process using the patient lifting device 100 following the stage of FIG. 11B. As can be seen, in the inflating condition 410 of FIG. 12, the first intermediate vertical layer air compartment 805 has become filled or mostly filled, and air is passing through the right side upper barrier valve 830 and the left side upper barrier valve 835 of the upper barrier valving system 235. As air is beginning to fill the top vertical layer air compartment 210, the weight of the patient 400, the relative rigidity of the top surface rigidifying structure 715, and the positioning of the valve pair again direct the air towards the peripheries and in particular towards the right side 120 and left side 125 so that the top vertical layer air compartment 210 is filled in a manner that elevates the sides of the top surface 130 in a way that creates the cradling condition. The upper barrier valving system 235 can be designed to allow air to flow from the first intermediate vertical layer air compartment 805 to the top vertical layer air compartment 210 at any stage or pressure during the filling of the first intermediate vertical layer air chamber 805, as discussed above.

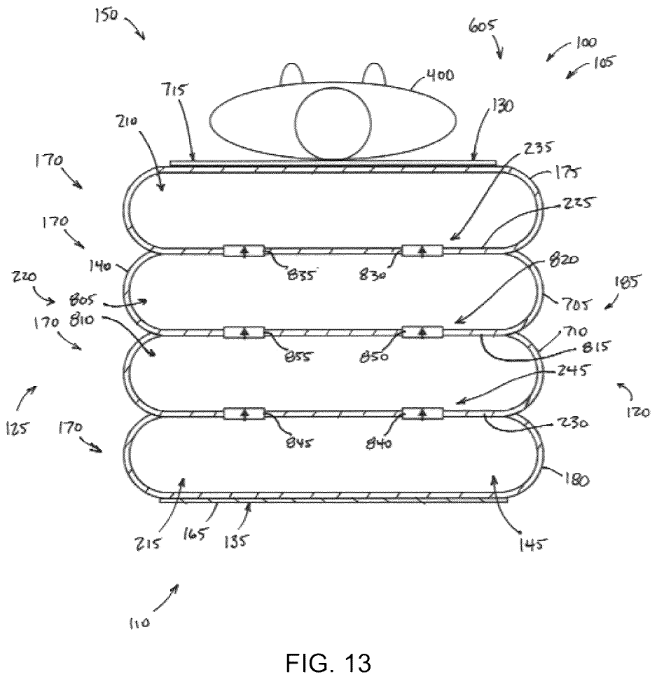

FIG. 13 shows the patient lifting device 100 of this version in an inflated condition 150 with the filling of top vertical layer air compartment 210 being completed following continued filling from the condition shown in FIG. 12. In the inflated condition 150, the air supply can be shut off or disconnected so that no more air flows into the pneumatic lifting system 145. As the top vertical layer air compartment 210 reaches its fully filled condition, the cradling condition subsides and the top surface 130 becomes more level. In this uncradling condition 605 with the leveled top surface 130, the patient can be easily transferred to another object such as a bed, gurney, wheelchair, or the like, as discussed above. After the patient has been transferred off the patient lifting device 100, one or more of the deflation openings 160 can be opened and the air within the air compartments 205 can be allowed to escape so that the patient lifting device 100 returns to its deflated condition 405.

The patient lifting device 100 can also be designed and configured to provide rapid filling from a deflated condition 405 to an inflated condition 150. In particular, the materials, valving, positioning of valving, and arrangement of the air compartments 205 can be selected and designed to increase the rate of filling. For example, the rate of filling of the patient filling device 100 is increased over existing devices by having a single air inlet 155 that fills all of the air compartments 205. In addition, the flow of air through all of the compartments 205 and the arrangement and number of compartments 205 is advantageously designed to provide rapid filling of the patient lifting device 100 to a desired height. For example, with the patient lifting device 100 of the invention, using an air supply that introduces air into the air inlet 155 at about 100 cubic feet per minute or less and at a pressure of 2 psi or less, a 200 pound patient can be lifted to a height of at least 30 inches in less than 75 seconds, and more preferably in less than 60 seconds.

The patient lifting device 100 can also be designed and configured to provide robust and powerful lifting from a deflated condition 405 to an inflated condition 150. In particular, the materials, valving, positioning of valving, and arrangement of the air compartments 205 can be selected and designed to increase the power of lifting. For example, with the patient lifting device 100 of the invention, using an air supply that introduces air into the air inlet 155 at about 100 cubic feet per minute or less and at a pressure of about 2 psi or less, an 800 pound patient or weight can be lifted to a height of at least 30 inches, and more preferably a 1000 pound patient or weight, and more preferably a 1200 pound patient or weight. The patient lifting device 100 is also designed to robustly provide reuse through at least 300 cycles.

The patient lifting device 100 can be made from any suitable material known in the art that provides sufficient air tightness and flexibility to achieve the results described herein. For example, in one version the body 105 of the patient lifting device 100 comprises one or more of nylon, reinforced nylon, teflon-coated nylon, PVC, and the like. In one version, the body 105 of the patient lifting device 100 is made of easily cleanable and/or antimicrobial material. In one version, the body 105 of the patient lifting device 100 is made of radiolucent and/or MRI compatible material for artifact free imaging if necessary.

The patient lifting device 100 can be used with any suitable air supply that provides sufficient air flow and/or pressure to fill the air compartments 205 of the patient lifting device 100 as described. For example, convention air mattress air supplies and/or connectors can be used. A particular air supply that is particularly useful is the PPS Glide Blower commercially available from Patient Positioning Systems in Annapolis, MD.

The valving systems of the patient lifting device 100 can be any suitable valves or systems, either customized or commercially available, that meet any of the design criteria described above. For example, the valve used can be check valves, one-way valves, two-way valves, or any other type of valve that serves to limit the flow from a lower compartment to an upper compartment, or from an upper compartment to a lower compartment if the inlet is positioned on the upper layer and the flow direction is reversed, until a desired pressure and/or fill is reached in the lower compartment. In one particular version, one or more of the valves of the patient lifting device 100 comprises a 2110P Hi-Flo Molded Relief Valve commercially available from Halkey Roberts of Saint Petersburg, FL, or the like. The 2110P valve is available at varying crack pressures, such as 0.2, 0.3, 0.5, 1.0, 1.5, 3.0. 5.0., and 7.0, each with differing flow rates as a function of back pressure as described at halkeyroberts.com/Products/2110-hi-flo-molded-relief-valves which is incorporated herein by reference.

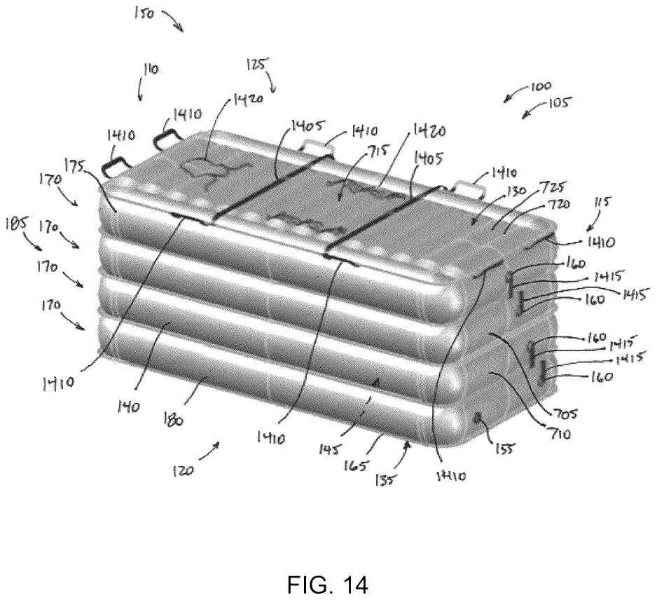

FIG. 14 shows another version of a patient lifting device 100 of the invention. The version of FIG. 14 is similar to the version of FIGS. 1 and 7, but with one or more additional accessories and/or features provided. For example, as can be seen in FIG. 14, the patient lifting device 100 can be provided with one or more straps 1405 for helping to secure a patient, with one or more handles 1410 for allowing the patient lifting device to be pulled or manipulated, one or more patient orientation indicators 1415, and/or one or more pull tabs 1420 on the deflation opening 160.

As used herein, with regard to the first end 110, second end 115, right side 120, and left side 125 when it comes to the location and/or orientation of components, by first end it is meant the 20 percent, or 10 percent, of the longitudinal extent of the patient lifting device 100 near the terminal end of the patient lifting device 100 in the first end direction, which may be in the patient's head direction. By second end it is meant the 20 percent, or 10 percent, of the longitudinal extent of the patient lifting device 100 near the terminal end of the patient lifting device 100 in the second end direction, which may be the patient's foot direction. By right side it is meant the 50 percent of the patient lifting device 100 extending to the right of a longitudinal center line or plane of the patient lifting device 100. By left side it is meant the 50 percent of the patient lifting device 100 extending to the left of the longitudinal center line or plane of the patient lifting device 100. For example, an item positioned on the right side would be positioned on the right half of the patient lifting device 100 not including the center line, and more preferably at least about 10 percent or at least about 20 percent of the transverse length of the patient lifting device 100 to the right of the center line or center plane, and an item positioned on the left side would be positioned on the left half of the patient lifting device 100 not including the center line, and more preferably at least about 10 percent or at least about 20 percent of the transverse length of the patient lifting device 100 to the left of the center line or center plane.

While the patient lifting device 100 is described and shown herein has having the air inlet 155 on the bottom vertical layer 180 so that the air compartments 205 are filled generally from bottom to top, other arrangements are also possible. For example, the air inlet can be on the top vertical layer 175 and the air compartments 205 can fill generally from the top to the bottom with the valves discussed above reversed. Alternatively, the air inlet 155 can be positioned on the intermediate vertical layer 185 and the fill can occur both up and down with the valve positioning adjusted accordingly.

Although the present invention has been described in considerable detail with regard to certain preferred versions thereof, other versions are possible, and alterations, permutations and equivalents of the versions shown will become apparent to those skilled in the art upon a reading of the specification and study of the drawings. For example, the cooperating components may be reversed or provided in additional or fewer number, and all directional limitations, such as top and bottom, upper and lower, right and left and the like, can be switched, reversed, or changed as long as doing so is not prohibited by the language herein with regard to a particular version of the invention. Like numerals represent like parts from figure to figure. When the same reference number has been used in multiple figures, the discussion associated with that reference number in one figure is intended to be applicable to the additional figure(s) in which it is used, so long as doing so is not prohibited by explicit language with reference to one of the figures. Also, the various features of the versions herein can be combined in various ways to provide additional versions of the present invention. Furthermore, certain terminology has been used for the purposes of descriptive clarity, and not to limit the present invention. Throughout this specification and any claims appended hereto, unless the context makes it clear otherwise, the term “comprise” and its variations such as “comprises” and “comprising” should be understood to imply the inclusion of a stated element, limitation, or step but not the exclusion of any other elements, limitations, or steps. Throughout this specification and any claims appended hereto, unless the context makes it clear otherwise, the term “consisting of” and “consisting essentially of” should be understood to imply the inclusion of a stated element, limitation, or step and the exclusion of any other elements, limitations, or steps or the exclusion of any other essential elements, limitations, or steps, respectively. Throughout the specification, any discussion of a combination of elements, limitations, or steps should be understood to include (i) each element, limitation, or step of the combination alone, (ii) each element, limitation, or step of the combination with any one or more other element, limitation, or step of the combination, (iii) an inclusion of additional elements, limitations, or steps (i.e. the combination may comprise one or more additional elements, limitations, or steps), and/or (iv) an exclusion of additional elements, limitations, or steps or an exclusion of essential additional elements, limitations, or steps (i.e. the combination may consist of or consist essentially of the disclosed combination or parts of the combination). All numerical values, unless otherwise made clear in the disclosure or prosecution, include either the exact value or approximations in the vicinity of the stated numerical values, such as for example about +/− ten percent or as would be recognized by a person or ordinary skill in the art in the disclosed context. The same is true for the use of the terms such as about, substantially, and the like. Also, for any numerical ranges given, unless otherwise made clear in the disclosure, during prosecution, or by being explicitly set forth in a claim, the ranges include either the exact range or approximations in the vicinity of the values at one or both of the ends of the range. When multiple ranges are provided, the disclosed ranges are intended to include any combinations of ends of the ranges with one another and including zero and infinity as possible ends of the ranges. Therefore, any appended or later filed claims should not be limited to the description of the preferred versions contained herein and should include all such alterations, permutations, and equivalents as fall within the true spirit and scope of the present invention.

What is claimed is:

1. A patient lifting device for pneumatically lifting a fallen patient, the patient lifting device comprising:
a body extending longitudinally from a first end to a second end and transversely from a right side to a left side, the body comprising a top surface adapted to have a patient positioned thereon, a bottom surface adapted to contact a floor, ground, or other surface, and a pneumatic lifting system between the top surface and the bottom surface and adapted to be inflated to lift the top surface relative to the bottom surface,
wherein the pneumatic lifting system comprises a top vertical layer having a top vertical layer air compartment, a bottom vertical layer having a bottom vertical layer air compartment, an intermediate vertical layer having an intermediate layer vertical air compartment, and an air inlet connectable to an air supply which can inflate the pneumatic lifting system,
wherein an upper barrier separates the top vertical layer air compartment from the intermediate vertical layer air compartment and a lower barrier separates the bottom vertical layer air compartment from the intermediate vertical layer air compartment,
wherein the upper barrier comprises an upper barrier valving system that allows air to pass from the intermediate vertical layer air compartment to the top vertical layer air compartment and the lower barrier comprises a lower barrier valving system that allows air to pass from the bottom vertical layer air compartment to the intermediate vertical layer air compartment, and
wherein the pneumatic lifting system is designed so that the patient lifting system can lift a patient to a height of at least 30 inches in less than about 90 seconds.

2. A patient lifting device according to claim 1 wherein the upper barrier valving system and the lower barrier valving system are positioned on the first end of the body.

3. A patient lifting device according to claim 1 wherein the upper barrier valving system and the lower barrier valving system are positioned on the first end of the body so that all valves of the pneumatic lifting system are on the first end of the body.

4. A patient lifting device according to claim 1 wherein the top vertical layer air compartment, the bottom vertical layer air compartment, and the intermediate vertical layer air compartment are open compartments devoid of baffles.

5. A patient lifting device according to claim 1 wherein the pneumatic lifting system is designed so that the patient lifting system can lift a 200 pound patient to a height of at least 30 inches in less than about 75 seconds when connected to an air supply that supplies air at about 100 cubic feet per minute or less and at a pressure of about 2 psi or less.

6. A patient lifting device according to claim 1 wherein the pneumatic lifting system is designed so that the patient lifting system can lift a 200 pound patient to a height of at least 30 inches in less than about 60 seconds when connected to an air supply that supplies air at about 100 cubic feet per minute or less and at a pressure of about 2 psi or less.

7. A patient lifting device according to claim 1 wherein the pneumatic lifting system is designed to provide a cradling effect during the lifting of the patient where the pneumatic lifting system causes a portion of the top surface to the right side and left side of the patient to be at a higher elevation than the elevation of the top surface that is directly under the patient.

8. A patient lifting device according to claim 7 wherein the pneumatic lifting system is designed to provide the cradling effect throughout a lifting process.

9. A patient lifting device according to claim 1 wherein the upper barrier valving system comprises a right side upper barrier valve and a left side upper barrier valve.

10. A patient lifting device according to claim 9 wherein the right side upper barrier valve and the left side upper barrier valve are located on the first end of the patient lifting device body.

11. A patient lifting device according to claim 9 wherein lower barrier valving system comprises a right side lower barrier valve and the left side lower barrier valve.

12. A patient lifting device according to claim 1 wherein the air inlet is on the bottom vertical layer.

13. A patient lifting device according to claim 12 wherein the air inlet is one of the bottom vertical layer, top vertical layer, and intermediate vertical layer, and wherein the other two layers have no air inlet.

14. A patient lifting device according to claim 1 wherein the bottom surface comprises reinforced material designed to be useable on an outdoor surface and be dragged across the ground without becoming punctured.

15. A patient lifting device according to claim 1 wherein the intermediate vertical layer comprises a first intermediate vertical layer having a first intermediate vertical layer air compartment and a second intermediate vertical layer having a second intermediate vertical layer air compartment, wherein an intermediate barrier separates the first intermediate vertical layer air compartment from the second intermediate vertical layer air compartment, and wherein the intermediate barrier comprises an intermediate barrier valving system that allows air to pass from the second intermediate vertical layer air compartment to the first intermediate vertical layer air compartment.

16. A patient lifting device for pneumatically lifting a fallen patient, the patient lifting device comprising:
a body extending longitudinally from a first end to a second end and transversely from a right side to a left side, the body comprising a top surface adapted to have a patient positioned thereon, a bottom surface adapted to contact a floor, ground, or other surface, and a pneumatic lifting system between the top surface and the bottom surface and adapted to be inflated to lift the top surface relative to the bottom surface,
wherein the pneumatic lifting system comprises a top vertical layer having a top vertical layer air compartment, a bottom vertical layer having a bottom vertical layer air compartment, an intermediate vertical layer having an intermediate layer vertical air compartment, and an air inlet connectable to an air supply which can inflate the pneumatic lifting system,
wherein an upper barrier separates the top vertical layer air compartment from the intermediate vertical layer air compartment and a lower barrier separates the bottom vertical layer air compartment from the intermediate vertical layer air compartment,
wherein the upper barrier comprises an upper barrier valving system that allows air to pass from the intermediate vertical layer air compartment to the top vertical layer air compartment and the lower barrier comprises a lower barrier valving system that allows air to pass from the bottom vertical layer air compartment to the intermediate vertical layer air compartment, and
wherein the pneumatic lifting system is designed to provide a cradling effect during the lifting of the patient where the pneumatic lifting system causes a portion of the top surface to the right side and left side of the patient to be at a higher elevation than the elevation of the top surface that is directly under the patient.

17. A patient lifting device according to claim 16 wherein the pneumatic lifting system is designed to provide the cradling effect throughout a lifting process.

18. A patient lifting device according to claim 16 wherein the top surface comprises a top surface rigidifying structure over a portion of the top surface, wherein the top surface rigidifying structure is more rigid than a portion of the top surface that has no top surface rigidifying structure.

19. A patient lifting device according to claim 16 wherein the pneumatic lifting system is designed so that the patient lifting system can lift a 200 pound patient to a height of at least 30 inches in less than about 60 seconds when connected to an air supply that supplies air at about 100 cubic feet per minute or less and at a pressure of about 2 psi or less.

20. A patient lifting device according to claim 16 wherein the upper barrier valving system comprises a right side upper barrier valve and a left side upper barrier valve.

21. A patient lifting device according to claim 20 wherein the right side upper barrier valve and the left side upper barrier valve are located on the first end of the patient lifting device body.

22. A patient lifting device according to claim 16 wherein the lower barrier valving system or the upper barrier valving system is designed so that air is permitted to flow from the bottom vertical layer air compartment to the intermediate layer air compartment when the bottom layer air compartment is from about 80 percent to about 98 percent filled or so that air is permitted to flow from the intermediate vertical layer air compartment to the top layer air compartment when the intermediate layer air compartment is from about 80 percent to about 98 percent filled.

23. A patient lifting device according to claim 16 wherein the bottom surface comprises reinforced material designed to be useable on an outdoor surface and be dragged across the ground without becoming punctured.

24. A method of lifting a patient from the floor or ground, the method comprising:
providing a patient lifting device comprising a body extending longitudinally from a first end to a second end and transversely from a right side to a left side, the body comprising a top surface, a bottom surface, and a pneumatic lifting system between the top surface and the bottom surface and adapted to be inflated to lift the top surface relative to the bottom surface;
placing the bottom surface on the floor or ground;
positioning a patient on the top surface;
inflating the pneumatic lifting system to cause the top surface to move away from the bottom surface to lift the patient on the top surface;
cradling the patient while being lifted with a portion of the top surface; and
lifting the patient 30 inches in less than 75 seconds.
